(19) United States
(12) Patent Application Publication
(10) Pub. No.: US 2014/0267933 A1
(43) Pub. Date: Sep. 18, 2014

(54) Electronic Device with Embedded Macro-Command Functionality

(71) Applicant: TOSHIBA AMERICA INFORMATION SYSTEMS, INC., Irvine, CA (US)

(72) Inventor: Daniel E. Young, Murfreesboro, TN (US)

(73) Assignee: TOSHIBA AMERICA INFORMATION SYSTEMS, INC., Irvine, CA (US)

(21) Appl. No.: 13/841,252

(22) Filed: Mar. 15, 2013

(51) Int. Cl. H04N 5/44

(52) U.S. Cl. CPC H04N 5/4403
USPC 348/734

(57) ABSTRACT

According to an embodiment of the present invention, an electronic device includes a processor, a non-transitory memory coupled to the processor, the memory including a sequential list of commands, wherein the list is configured to be edited in regard to which command to be listed and to an order of commands and a receiver configured to receive an instruction to initiate execution of the commands, wherein the processor is configured to execute the commands in accordance with the order in the list based upon the instruction. The sequential list may be edited through, for example, a graphical interface of the electronic device or through a controller.

### TECHNICAL FIELD

The present application relates generally to an electronic device such as a digital television with embedded macro command functionality for controlling an operation of the electronic device.

### BACKGROUND

An electronic device such as a digital television has a multitude of features and capabilities that can make it easy to customize for individual applications (e.g., watching a black and white movie, playing a console video game with enhanced video settings) but can also become tedious and even difficult to switch between the applications. Although there are many products (e.g., infra-red [IR] remote controls and controller systems) that allow macro functionality to control a television (and other consumer electronic devices), all of these products act outside of the television (“external macro”) and are inherently susceptible to interference, improper placement, and other issues, thus leading to missed commands or incorrect command functionality. Once an individual command(s) is missed, the macro's operation sequence may be out of order and incorrect results will occur. Furthermore, there are limitations as to the number of macros that can be accommodated within a remote control as well as the complexity and kind of feature sets that macros residing outside of the television can handle.

Another issue with external macros is that the navigation of a television's menu system is generally performed via a remote control. The television menu system is a hierarchy of nested menus and individual selection items. To navigate the menu, a user presses a “Menu” key on the remote control, waits for the television to display the menu, and then highlights parts of the menu using the up/down/left/right (i.e., “navigation”) buttons on the remote control. Once highlighted, the individual menu item can be selected by pressing the “OK/Enter” (or equivalent) button on the remote control. This process continues until the desired menu item is accessed. The television menu system is closed by the user by pressing “Exit” (or equivalent on the remote control). When the user enters the television menu again, the menu typically returns to the top-most menu level, but does not necessarily highlight the same value every time. In many cases, the last top level menu item is automatically highlighted by default, so that the user can more quickly access the last menu item that they were navigating to. Yet another issue that occurs is that in certain modes, some television menu items are hidden or skipped; for example, video inputs can be hidden or item selections can be automatically skipped, depending upon an additional menu item. These behaviors may be advantageous for a human using the television remote control, but it is not necessarily beneficial when applied to automated operations, such as those based on external macros.

A further issue with the television menu navigation and control with external macro devices is that the state of the menu system is not known to the external macro device, because there is no feedback from the television to the external macro device. Without knowing which menu item is highlighted in the television menu system, the external macro device does not know where to navigate. The user can record a macro that performs the same menu navigation sequence (e.g., Menu-Down-Select-Down-Down-Select), but this sequence will not always result in accessing the same menu item each time it is called. Moreover, to change values (e.g., On/Off, numeric selection, etc), the external system would need to know the current value, but again there is no feedback so the current value is not known by the external macro device.

### SUMMARY

In view of the foregoing, there is a need to alleviate the issues described above. Accordingly, embodiments of the present invention relate to an electronic device with embedded macro command functionality that allows an operation of the electronic device to be controlled reliably, with more features and with ease, for example, from a remote control. Various embodiments of the present invention will be set forth in the following descriptions. Additional features and advantages over conventional ways will also be described. It is to be understood that these descriptions are exemplary and explanatory and no single one is solely responsible for the desirable attributes disclosed herein.

Embodiments of the present invention alleviate the above mentioned issues, and others, by moving macro functionality to within an electronic device itself. Thus, any number of operational commands that the electronic device is capable of (depending upon the feature set) as well as the control of other external devices can be sequenced into a logical order by a user. Commands inherent to the electronic device can thus be made error-free in regards to interference and placement issues associated with conventional devices. The addition of voice control to enable these macro operations creates a user friendly way to perform complex tasks.

According to an embodiment of the present invention, an electronic device includes a processor, a non-transitory processor storage including a sequential list of commands, wherein the list is configured to be edited in regard to which command to be listed and to an order of commands and a receiver configured to receive an instruction to initiate execution of the commands, wherein the processor is configured to execute the commands in accordance with the order in the list based upon the instruction. The command may be an executable file and the sequential list of commands may be configured to be executed by the processor without a need for compiling or assembling. The sequential list may be edited through, for example, a graphical interface of the electronic device or through a controller. The receiver may be further configured to receive the instruction from the controller, by use of sound such as human voice, through such interfaces as but not limited to HDMI, internet based communication, and the like. The electronic device may be configured to connect to the controller wirelessly or through a wire. The receiver may be configured to receive an external instruction from an external device. The electronic device may further include a transmitter to transmit the external instruction to the external device. The electronic device may be configured to generate the external instruction based on the list. The sequential list of commands can reside in any one or combination of an operating system, firmware, device driver, kernel, a set of micro codes and the like of the electronic device.

According to another embodiment of the present invention, a macro execution module configured to be embedded in an electronic device includes a processor, a non-transitory processor storage including a sequential list of commands configured to direct the processor to execute the commands in accordance with an order in the list, wherein the list is configured to be edited in regard to which command to be listed and to the order of commands, and a communicator configured to receive and transmit an instruction associated with the sequential list of commands, wherein the processor is configured to execute the commands based on the instruction. The communicator may be configured to receive the instruction from a controller or from an external device and to transmit the instruction to the external device. The communicator may be configured to receive and transmit the instruction through a wired connection or wirelessly. The macro execution module may be embedded in any electronic devices such as DVD player, media player, game console, electronic appliance, audio device, phone, computer and the like.

According to yet another embodiment of the present invention, a television includes a processor, a non-transitory processor storage comprising a first list of commands and a second list of commands, wherein the first list and the second list are configured to be edited in regard to which command to be listed in the first list and in the second list and to an order of the commands, a receiver configured to receive a voice audio instruction to initiate execution of the either the first list of commands or the second list of commands and a voice recognition module configured to recognize which one of the first list or the second list shall be executed and output a result, wherein the processor is configured to execute the commands in accordance with the order either in the first list or the second list based upon the result of the voice recognition module. The television may include an interface configured to electronically connect with an external electronic device and a communicator configured to transmit an external instruction to the external electronic device via the interface, wherein the processor may be configured to generate the external instruction based on the list.

### BRIEF DESCRIPTION OF THE DRAWINGS

FIG. 1 is a diagram of various components related to an embodiment of the invention.

FIG. 2 is a diagram of an example of a variation of an embodiment.

FIG. 3 is a flow chart illustrating an example macro creation process.

FIG. 4 is an example of a graphical user interface (GUI).

FIG. 5 is another example of the GUI.

FIG. 6 is an example of the GUI depicting transition from a command to a sub-command.

FIG. 7 is an example of macro action tables.

FIG. 8 is a flow chart illustrating an exemplary flow of creating a macro name.

FIG. 9 is a flow chart illustrating an exemplary method of binding a remote key sequence to a macro.

FIG. 10 is an exemplary flowchart of discovering macro names contained in a television.

FIG. 11 is a flowchart of three exemplary methods of activating a macro.

FIG. 12 is a flowchart illustrating an exemplary voice recognition method of activating a macro.

FIG. 13 shows an exemplary use of voice control to activate a macro.

FIG. 14 is an exemplary overview of an electronic device according to an embodiment.

FIG. 15 is an exemplary configuration including the electronic device of FIG. 14.

FIG. 16 is an exemplary configuration including an electronic device having a macro execution unit of an embodiment.

FIG. 17 is an exemplary view of a macro execution unit according to an embodiment.

### DETAILED DESCRIPTION OF SPECIFIC EMBODIMENTS

Various embodiments of the present invention are set forth herein with reference to the drawings for the purpose of describing various novel aspects. However, various modification and changes can be made therein without departing from the novel aspects.

Embodiments of this invention generally relate to a macro command feature set, embedded into an electronic device's software, which allows a sequencing of operational commands to both the electronic device and any external devices that the electronic device is capable of controlling. The sequence is customized by a user from within the electronic device user interface and is operated on via an electronic device control instruction(s). The sequential list of commands automates an operation of the electronic device and external devices that may otherwise involve individual control or use of a separate remote controller device. Activation of the macro command(s) are initiated for example, via a voice-control system that allows a remote free operation; this voice control operation can be embedded into the electronic device hardware and software, or can be remotely activated by an external device that can communicate with the electronic device. In addition to voice control activation, the system can also activate the macro commands via other fallback methods, namely the use of the electronic device's remote control or via a network command protocol that can be utilized by network connected devices that are registered to communicate and control the electronic device.

Certain aspects pertain to the location of the macro command functionality (internal to the electronic device's operation system or the like), using voice control to name a macro, using voice control to activate a macro, and using an IP based command message to activate a macro.

In an embodiment, the ability to act on multiple commands (e.g., change channel, change volume, change picture settings) is embedded into a television's software and controlled by a user via a macro feature within a television's graphical user interface. The user can create various macros in order to perform a succession of commands.

FIG. 1 shows various components related to an embodiment of the invention. A television 1 includes a macro 2 having a sequential list of commands embedded in a television software system 3 which is stored in a memory 4, a processor 5 configured to execute the macro 2, and a receiver 6. Examples of a wireless remote control 7 configured to communicate with the receiver 6 include, but are not limited to IR remote control, smart phone, tablet computer and the like. The various macros including those created by the user are stored in the memory 4. The wireless remote control 7 transmits an instruction designating a certain macro 2 to the receiver 6 of the television 1. The instruction acts on the television's software and initiates the processor 5 to sequentially execute the commands listed in the macro 2. This in turn controls an operation such as changing a channel, volume, input, all of these, or the like of the television. Because the macro 2 and the processor 5 reside within the television 1, more functionality can be embedded and the entire process can be performed reliably and faster compared with a conventional external macro device. For example, the macro can be associated with the change of an input from a satellite receiver to a DVD player in addition to adjusting the picture quality of the TV to accommodate the DVD movie quality.

FIG. 2 shows an example of a variation of an embodiment. The television 1 further includes a microphone 8 for receiving voice recognition commands, a voice processing engine 9 for reducing ambient noise, determining human voice recognition, performing speech detection, outputting voice recognition results to the television operating system 3 and the like, a predefined set of commands stored in the television software system 3, a software module for allowing user input (GUI) to create the sequential list of commands, a software module to detect and initiate execution of the sequential list of commands.

FIG. 3 shows a diagram describing an exemplary macro creation process related to an embodiment of the present invention. The creation of the macro can be performed on the television 1 via on-screen menu navigation (i.e., the television's graphical user interface), using the wireless remote control 7 or other method for navigating the television menu (e.g., smartphone or tablet application that allows for navigation of the television menu). Within a television software menu system, the user will navigate to the menu selection for Macros, which is shown as step 30 in FIG. 3, using a normal television navigation method such as IR remote control or smartphone/tablet control. From there, the user can navigate to menu selections for creating new Macros or editing existing Macros shown as step 31 in FIG. 3. In step 31, whether a new macro is to be created or an existing macro is to be edited is determined. If a new macro is to be created, a new macro name is created in step 32. If “Edit” is selected, then the existing macro is to be edited. From here, the create/edit processes are the same. In step 33, whether a new list of commands is to be created or an already existing list of commands is to be edited is determined. If step 34 is taken, a new list of commands is created. Otherwise, in step 35, an existing list is selected, however, if no list of commands has been created yet, then there will be no existing list and therefore this option would not be available. In step 36, command(s) is selected. When a list of commands is created (or selected for editing), a command is selected next (or modified if editing); this command is an action to be performed on the television or any connected device (ex: Volume Control). In step 37, if necessary, there could be sub-commands that can be next selected (ex: Volume Level=30%). Step 38 is for a time delay to apply after the command is sent, in order to allow for processing of the command/sub-command by the television or connected device. This setting may also be pre-determined by the system. In step 39, the user is prompted to either finish the macro creation process or go back to step 33 to do further editing as the system allows the user to add additional steps, in which case the process continues as described above. Step 40 concludes the macro creation process. The steps shown in FIG. 3 provide an example of macro creation process in relation to an embodiment of the present invention. Other sequence of steps may be performed or step(s) may be added or removed based on a particular application of alternative embodiments. In addition, the macro could be created by utilizing an application on a smartphone, tablet, computer or the like that is capable of communicating with the television.

FIG. 4 shows a graphical user interface (GUI) of this menu on the television 1. When creating a new macro, the macro is first assigned a name. The name creation can be automatically assigned by the television software (using a default text name with an incrementally appended numeric value) or the user can create the name using voice assistance, which is detailed below. When editing a macro, the user first selects the name of the macro to be edited. The user may also choose to rename or delete a selected macro.

FIG. 5 shows an example of a GUI on the television 1. After this point, the user can delete an existing step, reorder existing steps, edit an existing step or create a new step. After the macro name is assigned (or selected), the individual steps of the macro can be created (edited). As a step is created (edited), the user assigns an action command to that step, and in addition any sub-commands that may be applicable (described in the paragraph below).

FIG. 6 shows the GUI with a transition from a command (called an “Action”) to a sub-command (e.g., “Change Input”). The time delay is set next (described in detail below) or is set automatically by the system. After the step is finished, the user can finish the macro or add a new step, creating as many steps in the macro as the user desires and/or the system is allowed to handle. The commands (or “Actions”) are comprised of individual features or functions of the television, including (but not limited to): remote key operations, feature enabling and disabling, power control, and launching of certain applications from within the television. In addition, any control that the television may have on an external device is also a capable task for the macro function. The method in which the television can control an external device can include: IR remote codes, IP protocol, HDMI-CEC protocol, or other similar control method protocols. The complete list of commands that are allowed for macro creation is determined by the television software, as well as the total number of macros that can be created.

FIG. 7 shows an example of the Macro Action table. In cases where a command needs additional information in order to complete a task (examples include, but are not limited to: channel number entry, volume level selection, or video input selection), there will be a sub-command selection to allow refinement of the command to the most basic level [examples: Command=Volume, sub-Command=40%, Command=Input, sub-Command=HDMI2]. See FIG. 5 for reference.

The commands or “Actions” that the television 1 can perform on itself is determined by the television software architecture. As such, important features can be included in the macro command feature set, especially features that are otherwise hidden deep within the television's menu structure. The available method of accessing such features based on conventional techniques is via the television's graphical navigation system, and may involve dozens (or more) of remote control key presses in order to access a feature's menu item. As such, this embodiment of the present invention is unique in that the macro command feature allows for immediate access to these feature settings, which is otherwise not obtainable with other conventional methods of control, or highly complex with external macro-capable devices (and thus highly susceptible to interference and missed commands).

The commands or “Actions” that the television 1 can perform on external devices are not solely based on IR remote commands, as is the case with most conventional external macro command devices. Unique to this embodiment is the ability to utilize any control method(s) that the television 1 may employ in order to control external devices. Televisions with built in IR Blaster support (IR commands for multiple external devices, such as DVD players and cable set-top boxes) can utilize this support in the macro feature to control external devices. Televisions with HDMI-CEC (control protocol for the HDMI audio/video interface) can also incorporate HDMI-CEC control into the macro command feature. Televisions with other external control methods (e.g., network protocol support, etc.) can also include these control methods as applicable commands (“Actions”) in the macro feature. The control method is not obvious to the end user, however. From the point of view of the television user, the control method is not displayed, the command itself; this is to aid in user friendliness and make the macro command feature set easier to use and understand.

The list of available commands for the Macro can be updatable via software update (e.g., Smart TVs can be updated via Internet), to allow for future expansion of the macro command feature set. With Smart TVs, many applications are added (or updated) after the release of the television product. These “apps” are downloaded by the end user at a later date, and may not be known at the time of the television's production and development. As such, there is no way to include these specific apps in the macro command feature before product launch. However, by updating the television software, the macro command feature set can be extended to include these apps. This allows for an expanded macro command feature set as new apps are added to the Smart TV.

To allow for processing times that can vary from command to command, the macro command may also include a time delay setting. The delay setting will be applied after the individual step command sequence has been issued, in order to allow for the television (or externally connected devices) to properly process the command. For commands internal to the television, it may be acceptable to have the television system process commands as fast as possible, because the television system can know when a command has completed. However, in the case of externally connected devices, it may not be known when a command has completed, so allowing the user to select a delay time will give the external device time to complete an action before the macro moves on to the next command. If the user does not specify a delay time for a command, then the system can use a predetermined time delay.

FIG. 8 shows several exemplary methods of accomplishing the macro name creation related to an embodiment of the present invention. Step 80 indicates a step where the user may navigate to in order to create a macro name. In step 81, whether to record a macro name (move to step 83) or to rely on an automatic naming by the television system (move to step 82) is determined. Step 82 indicates a very basic method allowing the television software system to automatically name the macros, using an incremental numeric indication (e.g., Macro_{—}01, Macro_{—}02, . . . , Macro_N); this method is used in FIG. 3. Another method for macro naming (not shown in FIG. 8) is to allow the user to input the name using text entry; this can be accomplished by the user from a standard television remote control device, a keyboard attached to the television, or any other device or method that allows for text entry to the television. Steps 83-86 shows an example of a voice enabled method, unique to embodiments of this invention, allows the user to name the macro using a speech-to-text voice system. The system prompts the user to speak the macro name. As the user speaks, the system records the voice in step 83 and converts the speech to text in step 84. The television displays the converted speech to the user in step 85, allowing the user to repeat the process as often as necessary in step 86. When the user is satisfied with the text conversion, the system saves the text as the macro name in step 87.

FIG. 9 describes an exemplary method of binding a remote key sequence to a macro in relation to an embodiment of the invention. Step 90 indicates a step where the user may navigate to, in order to bind a remote key sequence to a macro. In the television menu system, in step 91, the user selects the Macro name, using normal television navigation methods such as IR remote control or smartphone/tablet control. In step 92, the television menu system then prompts the user to press the key sequence they want to bind to the macro. As the user presses the remote key sequence, the television displays the result for the user's acceptance. In steps 93-94, when the user is satisfied with the remote key binding, the television menu system then saves the binding to memory. This memorized key sequence can then be used to activate the macro.

FIG. 10 shows an exemplary flowchart illustrating a mechanism for an IP enabled device to discover the macro names contained within the television in accordance with an embodiment of the present invention. The television and device are connected to the same IP network and have an authentication pairing mechanism to provide security. In step 101, the device makes a request to the television to find macro names contained in the television. If the television is found to be paired to the device, in step 103, the television will perform authentication before proceeding with any device request. After authentication is validated, in step 104, the device makes a GET request to discover the macro names. In steps 105-106, the television will reply with a list of the macro names it has stored in its memory. This list of names can then be used to activate an individual macro name.

FIG. 11 shows three exemplary methods of accomplishing enablement of a macro in accordance with an embodiment of the present invention:
Step 110A By choosing this step, Voice control activation is used to enable a macro. A voice control system includes hardware and software that can be internal to the television or an external device that can be connected to the television, will allow a user(s) to speak a command phrase that will activate the macro. The voice control system can convert the user's spoken words to text and transmit a message to the television software system. The television software system can recognize the message and activate the macro, or the voice control system can recognize the spoken words and create a signal to send to the television software to activate the macro.
Step 110B By choosing this step, IP Network messaging is used to enable a macro. Using a network connection, the television will recognize commands from a registered device and when a macro command message is received, the macro will be activated.
Step 110C By choosing this step, Remote Key activation is used to enable a macro. Using a television remote control, pressing a specific key sequence will activate the macro.
   After one of the three methods described above is chosen and the macro has been received in step 111, the television software will select the macro (Macro X) and load the individual items of the macro into a list to be processed. In step 112, an index n, which designates a particular item to be processed in the list, is initialized. Each item in the list contains command(s), any sub-command(s), and associated time delay to that item. In steps 113 through 118, the television system processes each item one after another while incrementing the index n each time in step 118 until all items have been completed at step 119. For commands that act on the television, the television system will handle them internally. For commands that act on external devices connected to the television, the television system will send the commands using the control protocol configured for that device (examples include, but are not limited to: IR remote control, RS232 control, IP network control, HDMI CEC control).

An exemplary voice recognition method in accordance with an embodiment of the invention is described below. Voice recognition is accomplished via a microphone located in the television, which is capable of detecting audio from the human user, and a speech recognition system that can detect human speech and determine if the speech is a valid command for the television to recognize. In a noisy environment (such as a family living room where a television is located), voice recognition can be difficult without some special consideration given to the television's audio level and overall ambient sound levels. To recognize speech from a user, the speech recognition system can utilize several well established methods for employing background noise reduction, elimination of interference from the television speaker, and speech processing. Television speaker interference reduction can be accomplished mechanically via the microphone's physical enclosure (aka “beamforming”), such that sound waves from the television's internal speakers do not directly enter the microphone, reducing the amount of audio that is coming from the television itself. Noise reduction can be accomplished electronically by setting sound level thresholds, below which the speech recognition system will ignore the audio and not attempt to detect speech. In addition, noise can further be reduced by monitoring the television audio information that is being output to the television speakers, and eliminating the same audio (sound level is weighted depending upon the amount of similar audio information detected by the microphone) from the microphone audio output.

FIG. 12 shows an exemplary process flow of a voice recognition method based on a trigger word in accordance with an embodiment of the present invention. The use of a special “trigger word” is used to increase the response time and reliability of the voice detection software. This trigger word is a pre-determined word or short phrase that the speech recognition system is finely tuned to detect (regardless of human dialect, pitch, or other variations of vocal pattern). The trigger word can thus be detected with a high level of confidence by the voice detection software. In step 120, the speech recognition system monitors an output from a microphone audio. In step 121, if the output is above a sound level threshold, the speech recognition system will proceed to step 122A where a speech recognition audio is identified by subtracting a television speaker audio from the micro phone audio. This is followed by a speech recognition processing in step 122B. In the following step 123, the speech recognition system monitors for the trigger word. Once the trigger word is detected, the speech recognition system can then immediately begin monitoring for other valid voice commands that could initiate a macro. By looking for the trigger word, the speech recognition system can perform more reliably and also more quickly, since it does not have to iterate over the entire set of allowable voice commands. In addition, the speech recognition system can also control the television volume to assist with voice recognition. In step 124, upon detection of the trigger word, the speech recognition system can reduce the television volume to a predetermined level, allowing the microphone to more accurately detect the user's voice in order to respond to subsequent voice commands. In step 125, if no voice command is detected within a set timeout, the speech recognition system will return the television to the previous volume state in step 126, and return to step 120 to monitor the microphone audio output and to listening for the trigger word again (which it can do with better accuracy despite more ambient noise). Until the set timeout is reached, the speech recognition processing is repeated in step 127 to check if a macro name is spoken in step 128. If a macro name is recognized, the television volume is restored to the previous state in step 129, and the identified macro is performed in step 130.

FIG. 13 depicts the use of voice control to activate a macro. With the voice detection feature enabled and a macro stored in the television (e.g., “Macro 1”), the user first speaks the trigger word (e.g., “Hello TV”) to activate a television voice detection system. While the user is speaking the Macro name (“Macro 1”), the television voice detection system is simultaneously displaying a graphic interface depicting the voice control “listening” system. This graphic interface is to inform the user that the television is now listening for a voice command; if the trigger word was not detected, the absence of the graphic interface would allow the user to realize that the television is not listening for voice commands, and the user could repeat the trigger word again. With the trigger word detected and the television voice detection system listening for voice commands, the television voice detection system will detect the user's spoken words (“Macro 1”) and determine that the spoken text matches a valid Macro command. The television will then display the macro name to the user (as a confirmation of the reception of a valid command and a display of what further functionality is about to be performed) and then proceed to perform the macro operation.

### Advantage Over Conventional External IR Macro Device

The macro feature is a software system within the television software, and as such does not need to navigate the user interface in order to change a value internal to the television system; moreover, it does not need to rely on timing issues with menu navigation, as it can bypass the menu altogether. When controlling other external devices via IR remote control, embodiments of the present invention may face the same situation as described above (i.e., controlling external device's menu systems can be difficult), and so can allow for time delays between steps that control external devices. However, the inclusion of other control protocols such as HDMI-CEC helps to solve the problem of controlling value selections (on/off, numeric values) with other devices, since the ability to send specific value commands is part of the HDMI-CEC specification. For example, the television can send a command to power On an external device, without needing to know if the device is currently powered On or Off; likewise, the television can send a value for Volume to an externally connected audio receiver as a HDMI-CEC command, without needing to know the audio receiver's current volume level. The macro command would allow the user to specify a volume level, and the television would then send HDMI-CEC command to control the audio receiver as part of the macro command execution.

### Simplify Operation of Switching Television Input and Mode Settings

An example of the advantages of this control mechanism can be described in the following example. An entertainment system is comprised of the following items:
1. A television (containing the voice-activated macro system described here). This television also contains the following features: HDMI-CEC control, and a Game Mode picture setting.
2. A Game Device that is connected to the television via HDMI audio/video interface. This connection also allows HDMI-CEC control, which is a control protocol that operates over the HDMI interface.
3. An Audio/Video (A/V) Receiver that is connected to the television via HDMI. This connection also allows for HDMI-CEC control.
   HDMI-CEC control allows the television to control the power status of the Game Device and the A/V Receiver, as well as the volume level of the A/V Receiver.

Once the entertainment system above is setup and configured by the user, a typical scenario would be to turn on the Game Device and play a game. When playing a game, the television can be configured for optimum game response via “Game Mode”; this mode reduces the amount of video processing in the television in order to improve the response time between the game controller and the corresponding action show on the television screen. This setting is usually found in the Picture settings menu of the television, which is a sub-menu of the television's main graphical menu system. Audio levels can also differ greatly between devices, so adjustment of the volume control is typically needed when changing to the Game Device.

The scenario to play a game on the Game Device in this example is as follows:
1. Turn on A/V Receiver using A/V Receiver remote control.
2. Turn on Game Device using game controller.
3. Change TV Input to HDMI 2 using television remote control.
4. Change A/V Receiver volume using A/V Receiver remote control.
5. Turn on “Game Mode” in the television menu system using the television remote control (this would include several additional steps to navigate the television menu).

With HDMI-CEC control, this control scenario is improved in the following ways:
Turning on the television will automatically turn on the A/V Receiver
Changing inputs to HDMI 2 will automatically power on the Game Device
Changing volume on the television remote will automatically change volume on the A/V Receiver
   So now the steps become as follow:
1. Change TV Input to HDMI 2 using television remote control (this also turns on Game Device).
2. Change volume on A/V Receiver using television remote control.
3. Turn on “Game Mode” in the television menu system using the television remote control (this would include several additional steps to navigate the television menu).

The addition of HDMI-CEC control reduces the number of steps taken for this example, and also allows the user to use the television remote control to perform all the actions necessary. However, there are still several steps that are to be taken, notably the navigation of the television menu to access “Game Mode”.

Embodiments of the invention described here can reduce this example to a few spoken words. First, the user creates a new Macro in the television Menu system. The macro is named (e.g., “Play Game Device”). The steps of the Macro are as follows (note that these are the same steps as above):
1. TV Input: HDMI 2
2. TV Volume: 25
3. TV Picture Settings: Game Mode

The creation of the macro is no more time consuming than the original scenario, and is to be performed one time. Once the macro is created in the television Menu system, the user can simply speak the Trigger Word plus Macro Name (“Hi TV, Play Game Device”) and the television will perform the macro steps, eliminating the need for the television remote control and the navigation of the television menu system.

This scenario could be duplicated by an external device capable of macro commands and IR remote control, but without the ability to set the “Game Mode” feature on the television. This feature could not be accessed because the external device has no way of knowing where in the television menu the feature is, and has no way of accurately determining the television menu state (due to the reasons explained above).

### Simplify Launching of Internet Related Content

An additional example can also be made for Internet enabled TVs (aka “Smart TV”). Smart TVs can access Internet web pages and also contain third party applications (aka “Apps”) that allow access to Internet related content, such as streaming video and online gaming. These apps are often preloaded with the Smart TV, but can also be added to the Smart TV via a software update. Although some preloaded apps may have a dedicated button on the Smart TV remote control, most do not, and therefore it can take several steps to navigate the Smart TV menu system in order to launch an app. Likewise, web pages can usually be saved as a bookmark, but accessing a saved web page will also involve navigating the Smart TV menu system. Based on embodiments of the invention described here, the user can assign a macro that will automatically launch an app or a favorite web page. Then, the macro can be called (via voice command or the remote control key sequence, for example) and the Smart TV will launch the app or webpage without the need to navigate the Smart TV menu system.

Scenario (with no macro)

1. User enters Smart TV Menu system.

2. User navigates to Internet application (or web page link).

3. User selects application to launch.

Scenario (with macro)

1. User speaks trigger word and macro name.

2. Smart TV launches application.

Again, the creation of the macro is no more difficult than the original scenario of launching the application and is performed one time.

Another embodiment of the present invention relates to an electronic device such as a DVD player having a DVD macro command feature set, embedded therein, which allows sequencing of operational commands to both the electronic device and any external device having a macro command feature set embedded therein. The electronic device that has an operating system, firmware, device driver, kernel or the like can take advantage of a macro command feature set embedded within. A macro in the macro command feature set can act on any of the operating system, device driver, firmware, kernel, micro codes or the like to control an operation of the electronic device. An executable file may also be an operational command so that a processor can process the executable file without need for compiling or assembling. The sequence of operational commands can be programmed using any of the methods described above in relation to the first embodiment. Some examples of programming a macro include, but are not limited to the voice based programming, programming through the electronic device user interface, IP based interface, and by a remote control.

FIG. 14 shows an example of a DVD/media player 141 embedded with a DVD/media macro command feature set 142 and a DVD/media communicator 146 therein. The DVD/media player 141 also includes a processor 145 and a memory 144 in which a main software system 143 including the macro command feature set 142 is stored. The main software system 143 also manages a graphical user interface (GUI) 148. The DVD/media player 141 can communicate via the DVD/media communicator 146 with a DVD/media remote control 147 either wirelessly or through a wire. Sequencing of operational commands in a macro of the DVD/media macro command feature set 142 can be programmed through the use of the DVD/media GUI 148 and the DVD/media remote control 147 in a similar manner as the first embodiment. A macro menu residing within the DVD/media player 141 and listing available macros in the DVD/media player 141 may be displayed on the DVD/media GUI or alternately transmitted through the communicator 146 to the DVD/media remote control 147 upon a user's request. By looking at the list, the user can select one of the macros in the list and transmit information of the selected macro to the DVD/media communicator 146 of the DVD/media player 141. When the DVD/media communicator 146 receives the macro select information, it activates the selected macro and the processor 145 starts execution of the macro which in turn causes the DVD/media player 141 to perform an operation prescribed by the selected macro.

FIG. 15 shows an example of a configuration including the DVD/media player 141, the DVD/media remote control 147 and a television 1. The television 1 includes a television macro command feature set 2 and a television communicator 16. The DVD/media communicator 146 can transmit information to any external device such as the television 1 that has a macro command feature set and a communicator embedded therein and can accept information related to its macro command feature set. As shown in FIG. 15, the television macro command feature set 2 is configured to accept information from the DVD/media player 141 through the DVD/media communicator 146 and the television communicators 16. The information sent from the DVD/media player 141 to the television set 1 is used to control an operation of the television set 1 by activating one of the macros in the television macro command feature set 2.

Macros in the DVD/media and television macro command feature sets can be compatible, but they need not to be compatible, because the configuration shown above relies on information related to a macro command feature set in order to control the operation of the television or DVD/media player, not necessarily on a particular macro itself. The DVD/media player can have its own macro command feature set based, for example, on its operating system, device driver or the like.

In a case when macros are not compatible, for example, a macro interpreter residing in the television 1 can translate a DVD/media macro to a television macro as necessary. A configuration such as the one described above, allows the DVD/media remote control 147 to control an operation of the television 1 using information from the DVD/media player 141 transmitted via the DVD/media communicator 146 to the television 1. In other words, any electronic device having a macro command feature set and a communicator that can accept necessary information from the DVD/media macro command feature set of the DVD/media player 141 can be controlled by the DVD/media remote control 147. This configuration allows more reliable operation, greater flexibility and more features of the external device to be controlled by the DVD/media remote control 147 compared with a conventional universal remote control.

Similarly, a television remote control 17 of the television 1 through the television communicator 16 can control an operation of the DVD/media player 141 and/or any other electronic device having a macro command feature set and a communicator. This configuration is not limited to the above described devices, namely DVD/media player, television set and an external device. Any number of electronic devices, each having a macro command feature set and a communicator can control and can be controlled based on use of their macro command feature sets. Furthermore, instead of relying on a remote control, a voice activation method, and IP based control, those that are similar to the methods described above in relation to an embodiment can also be used.

Programming a macro can be accomplished in a similar manner as the programming method used in another embodiment. For those electronic devices that do not have a GUI, programming can alternately be accomplished by an offline programming using software capability and GUI of a computer or a television. After a macro is programmed offline, it can be downloaded to the electronic device via, for example, through IP based network.

An advantage of having a communicator is the ability to have an instruction that can indicate the end of a macro execution in an electronic device. This instruction can be sent to an external device through the communicator, so that the external device may not have to rely on a time delay setting to execute a next step in a macro. Rather, the external device can wait for this instruction, or rely on both the instruction and the time delay setting whichever is appropriate depending on a certain situation.

FIG. 16 shows a configuration based on another embodiment of the present invention. The configuration shown on FIG. 16 includes a television set 1, a DVD/media player 141, a game console 161 and a common remote control 17. A macro execution unit 198 is embedded in each of the television set 1, the DVD/media player 141, and the game console 161. The macro execution unit 198 includes a processor 195, a memory 194 and a communicator 196. The memory 194 can store a part or an entire set of a macro command feature set 192 and an operating system, firmware, device driver, kernel, micro code or the like. The processor 195 of the macro execution unit 198 is configured to execute a macro of the macro command feature set 192 stored in the memory 194. The common remote control 17 is configured to communicate with the communicator 196. For example, information related to the macro command feature set 192 can be transmitted to the communicator 196 by the common remote control 17. The common remote control 17 can also program a macro through the communicator 196. The communicator 196 is configured to communicate with other communicators embedded in the devices within the configuration. Because each of the devices has the macro execution unit 198 embedded within, the common remote control 17 is capable of programming and controlling an operation of any of the devices. Further, because programming and controlling are based on the macro command feature set 192, the devices can be controlled securely, with more features and with other advantages that the embedded macro command functionality can offer as described in embodiments above.

FIG. 17 shows an example of a macro execution unit 198 that can be embedded in an electronic device to allow control of an operation of the electronic device based on a macro command feature set. The macro execution unit 198 has a processor 195, a memory 194 and a communicator 196. The macro execution unit 198 can be implemented in an integrated circuit, in a programmable device, in a printed circuit board or the like. The processor 195 is configured to execute a macro in the macro command feature set for controlling an operation of the electric device. The memory 194 can store a part of or an entire set of a macro command feature set. The communicator 196 is configured to send out information related to the macro command feature set or accept information from an external electronic device having a macro command feature set. When a macro execution unit is implemented in an integrated circuit, operational commands, macros, communicator and other features can be standardized to enhance further universality of remote controlling a plurality of electronic devices.

While certain embodiments have been described, these embodiments have been presented by way of example, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An electronic device comprising:
a processor;
a non-transitory memory coupled to the processor, the memory comprising an ordered list of commands, wherein the ordered list of commands is configured to be edited by a user, the ordered list of commands comprising user accessible usage settings; and
a receiver configured to receive an instruction to initiate execution of the ordered list of commands;
wherein the processor is configured to automatically execute, in order, each of the commands in the ordered list of commands after the receipt of the instruction for controlling reproduction of audio-visual material.

2. The electronic device of claim 1, wherein the command is configured to be an executable file.

3. The electronic device of claim 1, wherein the ordered list of commands is configured to be executed by the processor without compiling or assembling.

4. The electronic device of claim 1, wherein the receiver is configured to receive the instruction from an external control device.

5. The electronic device of claim 4, wherein the list is configured to be edited through the external control device.

6. The electronic device of claim 1, wherein the receiver is configured to receive the instruction based on voice audio.

7. The electronic device of claim 1, wherein the receiver is configured to receive the instruction through an HDMI interface.

8. The electronic device of claim 1, wherein the receiver is configured to receive the instruction through an internet based communication.

9. The electronic device of claim 1, further comprising an interface configured to electronically connect with an external electronic device; and
a communicator configured to transmit an external instruction to the external electronic device via the interface.

10. The electronic device of claim 9, wherein the processor is configured to generate the external instruction based on the list.

11. The electronic device of claim 1, wherein the ordered list of commands resides in any one or combination of an application program, an operating system, firmware, device driver, kernel, and a set of micro codes.

12. The electronic device of claim 1, wherein the ordered list of commands comprises changing a volume setting.

13. The electronic device of claim 1, wherein the ordered list of commands comprises changing an input source setting.

14. A macro execution module configured to be embedded in an electronic device comprising:
a processor;
a non-transitory memory coupled to the processor, the memory comprising an ordered list of commands, wherein the ordered list of commands is configured to be edited by a user, the ordered list of commands comprising user accessible usage settings; and
a communicator configured to receive an instruction associated with the ordered list of commands from an external device and to transmit an external instruction to the external device,
wherein the processor is configured to automatically execute, in order, each of the commands in the ordered list of commands after the receipt of the instruction, and
wherein the processor is configured to generate the external instruction based on the list.

15. The macro execution module of claim 14, where in the command is configured to be an executable file.

16. The macro execution module of claim 14, wherein the ordered list of commands is configured to be executed by the processor without compiling or assembling.

17. The macro execution module of claim 14, wherein the external device is a remote control.

18. The macro execution module of claim 14, wherein the order list of commands comprises changing an input source setting for the electronic device.

19. The macro execution module of claim 14, wherein the ordered list of commands comprises changing a channel setting for the electronic device.

20. The macro execution module of claim 14, wherein the ordered list of commands comprises changing a video input source setting and changing an audio input source setting for the television.

21. The macro execution module of claim 14, wherein the communicator receives and transmits the instruction through a wired connection.

22. The macro execution module of claim 14, wherein the communicator receives and transmits the instruction wirelessly.

23. The macro execution module of claim 14, wherein the wired connection is based on HDMI CEC control.

24. The macro execution module of claim 14, wherein the communicator communicates based on IR, Bluetooth, sound, or IP network.

25. A television comprising:
a processor;
a non-transitory memory coupled to the processor, the memory comprising a first ordered list of commands, and a second ordered list of commands, wherein the first ordered list and the second ordered list are configured to be edited by a user, the first ordered list of commands and second ordered list of commands comprising user accessible usage settings; and
a receiver configured to receive a voice audio instruction to initiate execution of the either the first ordered list of commands or the second ordered list of commands; and
a voice recognition module configured to recognize which one of the first ordered list or the second ordered list shall be executed and output a result,
wherein the processor is configured to execute, in order, each of the commands in either in the first ordered list or the second ordered list based upon the result of the voice recognition module.

26. The television of claim 25, wherein the command is configured to be an executable file.

27. The television of claim 25, wherein the first and second ordered lists of commands are configured to be executed by the processor without compiling or assembling.

28. The television of claim 25, further comprising an interface configured to electronically connect with an external electronic device: and
a communicator configured to transmit an external instruction to the external electronic device via the interface.

29. The television of claim 28, wherein the processor is configured to generate the external instruction based on the list.

30. The television of claim 25, wherein the first ordered list of commands comprises changing a video input source setting and a picture mode setting and the second ordered list of commands comprises changing an input source setting and a launch an application setting for the television.
